(19) United States
(12) Patent Application Publication
(10) Pub. No.: US 2006/0277112 A1
(43) Pub. Date: Dec. 7, 2006

(54) Tokens-based system for providing information to users

(75) Inventors: Sun Ming Lieu, Los Altos, CA (US); Thomas P. Maliska, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sun Ming Lieu, Los Altos, C A (US)

(21) Appl. No.: 11/292,937

(22) Filed: Dec. 2, 2005

Related U.S. Application Data
(63) Continuation of application No. 09/781,042, filed on Feb. 9, 2001, now abandoned.
(63) Continuation-in-part of application No. 09/502,863, filed on Feb. 11, 2000, now abandoned.
(60) Provisional application No. 60/181,666, filed on Feb. 11, 2000.

(51) Int. Cl. G06Q 30/00

(52) U.S. Cl. 705/26

(57) ABSTRACT

Techniques for providing information to users in response to information requests. An information request may manifest itself in various forms and may be generated in response to a variety of user actions. The present invention determines tokens corresponding to the information included in an information request. The present invention determines information to be provided to the user based on the tokens.

### CROSS-REFERENCES TO RELATED APPLICATIONS

This application is a continuation of and claims priority from U.S. patent application Ser. No. 09/781,042 (Attorney Docket No. 021790-000710US, previously 020004-000710US) filed Feb. 9, 2001 entitled “A TOKENS-BASED SYSTEM FOR PROVIDING INFORMATION TO USERS”, which in turn is a non-provisional of and claims priority from U.S. Provisional Patent Application No. 60/181,666 (Attorney Docket No. 021790-000700US, previously 020004-000700US) filed Feb. 11, 2000 entitled “SYSTEM AND METHOD FOR FACILITATING ELECTRONIC COMMERCE ACTIVITIES” and is also a continuation-in-part (CIP) application of and claims priority from U.S. patent application Ser. No. 09/502,863 (Attorney Docket No. 021790-000800US, previously 020004-000800US) filed Feb. 11, 2000 entitled “SYSTEM AND METHOD FOR FACILITATING ONLINE SHOPPING ACTIVITIES”. The entire disclosures of the afore-mentioned applications are herein incorporated by reference for all purposes.

The present application also herein incorporates by reference for all purposes the entire disclosure of U.S. patent application Ser. No. 09/780,987 (Attorney Docket No. 021790-000720US, previously 020004-000720US) filed Feb. 9, 2001 entitled “TECHNIQUES TO FACILITATE SHOPPING FOR PROJECTS”.

### COPYRIGHT NOTICE

A portion of the disclosure of this patent document contains material which is subject to copyright protection. The copyright owner has no objection to the xerographic reproduction by anyone of the patent document or the patent disclosure in exactly the form it appears in the U.S. Patent and Trademark Office patent file or records, but otherwise reserves all copyright rights whatsoever.

### BACKGROUND OF THE INVENTION

The present invention relates generally to the field of electronic commerce and more particularly to techniques for improving a user's online shopping experience and for enabling vendors to provide information to users in a customized manner in line with the vendor's business or marketing goals.

As a result of the widespread usage and popularity of communication networks, such as the Internet, electronic commerce has blossomed into a multi-billion dollar marketplace for both consumers and vendors alike in recent years. A wide variety of items (including products and/or services) can now be obtained or purchased by consumers via online transactions.

The World Wide Web (the “Web”) has further enabled users of the Internet to participate in commercial transactions from the comfort of their homes or offices. In the Web environment, information resources available via communication networks such as the Internet are typically stored in the form of hypertext documents called “web pages” which can be accessed by users of the Web. A web page may incorporate any combination of text, graphics, audio and video content, software programs, and other data. Web pages may also contain hypertext links to other web pages. Web pages are typically stored on web servers provided by content providers coupled to the Internet. Each web page is uniquely identified by an address called a Uniform Resource Locator (URL) that enables users to access the web page.

Users typically access and view web pages using a program called a “web browser” which may execute on a computer coupled to the Internet. Users provide URL information to the browser, either directly or indirectly, and the browser responds by retrieving one or more web pages from the Internet corresponding to the URL information provided to thee browser. The retrieved web page may then be displayed on the user's computer. Examples of browsers include the Internet Explorer browser program provided by Microsoft Corporation, and the Netscape Navigator browser provided by AOL Corporation, and others.

In an online environment, the success of an online vendor depends heavily on the vendor's ability to have access to and target potential customers to provided vendor-related information to the potential customers. Conventionally, in a web environment, vendors typically provide information to users via online product catalogs. In order to perform an online purchase, a consumer generally has to first access a particular vendor's web-site, browse one or more web pages displaying the vendor's online product/item catalog, select one or more items for purchase from the vendor's product catalog, and consummate the purchase of the selected items by authorizing payment, usually via a credit card. In this conventional online shopping model, the user generally has to know the URL address of the particular vendor's web page or web site before the online transaction can be performed. Given the explosion in the number of vendor web pages and web sites, consumers typically remember URL addresses for a very small percentage of the available vendor web pages and tend to access only those small percentage of web pages. Consumers may thus miss out on deals or promotions offered by vendors not accessed by the consumer. The above model is also not very beneficial for vendors, especially vendors who are not well known in the user community or new vendors, whose web addresses may not be known by the consumers. Consequently, such vendors are not able to effectively provide vendor related information to the users.

The disadvantages associated with the online shopping model discussed above gave rise to “affiliate networks” wherein online vendors enter into a partnership with web content providers, e.g. Amazon.com, Yahoo.com, Ehow.com, and others. According to this partnership, web content providers refer customers who access web pages of the content providers to the vendor's web pages. This is typically achieved by providing a URL link (which may be shown as a hyperlink, a banner, an advertisement, and the like) from a web content provider's web page to one or more vendors' web pages. When a consumer selects the URL link, the consumer's browser is redirected to a vendor's web site or web page corresponding to the selected URL link. The consumer may then perform online transactions at the vendor's web page according to the traditional online shopping model discussed above. The referring content provider is commonly referred to as an “affiliate” and the content provider's web page or web site is referred to as an “affiliate web page/web site” or “referring web page/web site.” Ideally, an affiliate site is a site which is accessed by a large number of customers on a regular and frequent basis.

While affiliation networks provide greater visibility to vendors than the traditional online shopping technique discussed above, they still require the consumer to visit individual vendor sites before an item may be purchased. It is akin to a consumer having to visit several different shops before deciding upon a particular shop to purchase the item. This process can be very time consuming and frustrating for an online consumer. Additionally, due to business reasons or other reasons, a particular affiliate may form partnerships only with specific vendors. As a result the consumer may miss out on deals or promotions offered by other vendors and vendors not participating in affiliate relationships may not be able to provide information to the users.

According to another conventional technique, a consumer may use a search engine (e.g. Yahoo™, Google™) to facilitate online purchases or to get information about topics of interest to the user. According to this technique, the consumer may provide words or phrases describing an item(s) to be purchased or a topic to the search engine. The search engine then uses the words/phrases provided by the consumer as keywords to identify web pages which contain the keywords. URLs corresponding to web pages which contain the one or more of keywords (“hits”) are then presented to the user. From the hit list presented to the user, the user has to then determine URLs corresponding to vendor web pages which can be tedious and time consuming as the “hits” quite often include URLs which are not relevant to the user's needs. After accessing the desired vendor's web page, the user may then purchase the item according to the traditional online shopping model discussed above.

However, in order to use a search engine, the consumer has to be able to form a query which adequately describes the item(s) to be purchased. This is not convenient or even possible for consumers who are not computer savvy or who are simply uncomfortable using computers. As a result, the “hits” list provided by the search engine is usually too narrow or too broad. This is further compounded by the use of a language, such as English, in which a particular query item or concept may be described using several different words (i.e. several synonyms) and combination of words. Since most search engines merely perform a keyword matching search, the search may miss vendor web pages which offer items of interest to the user but which use different words to identify the items from the words/phrases provided by the user to the search engine. Additionally, due to the keyword matching searches, the list of “hits” generally also includes web pages which are not relevant whatsoever to the consumer. Accordingly, a user's online shopping experience can be very time consuming. From the vendor's perspective, search engines do not provide facilities which allow vendors to specify/implement business or marketing rules aimed at influencing a consumer's shopping behavior, increasing vendor profitability, acquiring customers, and the like.

According to another conventional technique, text indexes are created in association with content published by web sites. These text indices provide a map to related products and electronic commerce sites. Hierarchical pop-up menus, frames, and new windows are then used to display the related web sites and products to the user. Examples of companies which provide these techniques include Autonomy, Yellow Brix, Semio. and Flyswat. However, systems using this technique cannot be easily configured by and for different vendors wishing to provide information to users.

Many times a consumer may also be interested in purchasing items related to information displayed to the user, for example, content information displayed to the user on a web page, or information displayed by other display systems. For example, a user may view a web page displaying a cake recipe and be interested in purchasing items related to that particular cake recipe. Conventional online shopping mechanisms, including affiliation networks, do not provide facilities allowing users to conveniently make such purchases.

In light of the above, there is a need for techniques which enable automated and seamless interchange of information between users and vendors such that a user's online experience is enhanced and vendors are allowed to provide information to users in a targeted, controlled, and customizable manner.

### SUMMARY OF THE INVENTION

The present invention provides techniques for providing information to users in response to requests for information. A request for information (or “information request”) may manifest itself in various forms and may be generated in response to a variety of user actions. The present invention determines tokens corresponding to the information included in an information request. The present invention determines information to be provided to the user based on the tokens. According to an embodiment of the present invention, the information provided to the user is targeted to the recipient user based on the user's actions which triggered the request for information and the context in which the actions are performed.

According to an embodiment of the present invention, techniques are discussed for providing information in response to an information request. An embodiment of the present invention may store a first set of rules identifying a plurality of tokens and information associated with the plurality of tokens. The embodiment may receive the information request from a first source, the information request generated in response to an action performed by the user. The present invention may determine a first set of tokens from the plurality of tokens corresponding to the information request, determine first information corresponding to the first set of tokens based upon the first set of rules, and communicate the first information to the first source.

According to another embodiment, the present invention may receive an information request from a first source, the information request generated in response to an action performed by the user. The embodiment of the present invention may determine a plurality of tokens corresponding to the information request, determine a plurality of vendors corresponding to the plurality of tokens, determine first information provided by the plurality of vendors corresponding to the plurality of tokens; and communicate the first information to the first source.

According to yet another embodiment, the present invention may receive an information request from a first computer system, the information request generated in response to an action performed by the user. The present invention may determine a plurality of tokens corresponding to the information request, and determine a plurality of vendors corresponding to the plurality of tokens. For each vendor from the plurality of vendors, the present invention embodiment may determine a set of tokens from the plurality of tokens associated with the vendor, communicate information related to the set of tokens to the vendor; and receive information from the vendor corresponding to the set of tokens. The information received from the plurality of vendors may then be communicated to the first computer system.

According to another embodiment of the present invention, a first computer system may be used to generate an information request in response to a user action, and to communicate the information request to a second computer system. The second computer system may be configured to receive the information request from the first computer, access a first set of rules identifying a plurality of tokens and information associated with the plurality of tokens, determine a first set of tokens from the plurality of tokens corresponding to the information request, determine first information corresponding to the first set of tokens based upon the first set of rules, and communicate the first information to the first computer system.

The foregoing, together with other features, embodiments, and advantages of the present invention, will become more apparent when referring to the following specification, claims, and accompanying drawings.

### BRIEF DESCRIPTION OF THE DRAWINGS

FIG. 1 is a simplified block diagram of a distributed computer network which may incorporate an embodiment of the present invention;

FIG. 2 is a simplified block diagram of a computer system which may incorporate an embodiment of the present invention;

FIG. 3 is a simplified high-level flowchart showing processing performed according to an embodiment of the present invention;

FIG. 4 depicts a web page which may generate an information request according to an embodiment of the present invention;

FIG. 5 depicts unstructured content information which may be included in an information request according to an embodiment of the present invention;

FIG. 6 depicts a category hierarchy according to an embodiment of the present invention;

FIG. 7 depicts a user interface which may be used to display information received from an SSPS in response to an information request according to an embodiment of the present invention; and

FIG. 8 is a simplified block diagram showing the various modules/engines which may be used to process an information request and provide information to the user in response to the information request according to an embodiment of the present invention.

### DESCRIPTION OF THE SPECIFIC EMBODIMENTS

The present invention provides techniques for enhancing a user's online experience. Embodiments of the present invention allow vendors to provide information to users in a seamless, integrated, and automated manner. According to an embodiment of the present invention, information which may be configured by vendors is communicated to users in response to requests for information received by the present invention. The present invention provides a dynamically configurable system which allows vendors to easily and in a flexible manner control information to be provided to users in response to requests for information.

A request for information (or “information request”) may manifest itself in various forms including a purchase request, a request for branding information, a request for marketing or promotional information, a request for suggestive advertising information, a request for e-commerce information, a request for information related to e-commerce sites/pages, and other like information requests and combinations thereof. An information request may be generated in response to a variety of user actions including a user accessing a web site or web page, selecting content information from a specific web page/site, invoking services provided by the present invention, performing online e-commerce transactions, configuring a purchase request, and the like.

The information communicated to the user in response to an information request may include promotional information, marketing information, branding information, advertising information, suggestive selling information, information related to purchasable items which can be purchased by the user, and the like. According to an embodiment of the present invention, the information is targeted to the recipient user based on the user's actions which triggered the request for information and the context in which the actions are performed.

Features of the present invention embodied in the “Contextual e-Commerce”™ system services provided by ShopEaze Systems, Inc.

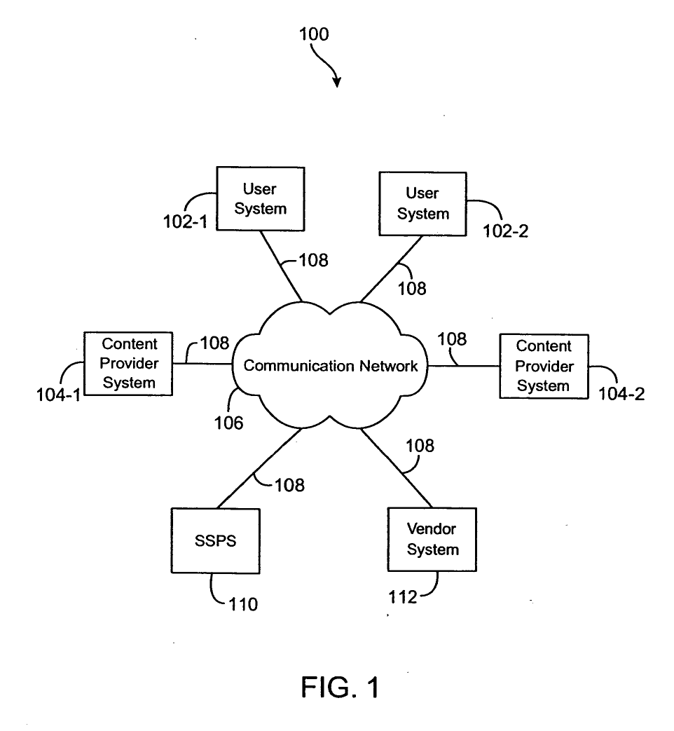

FIG. 1 is a simplified block diagram of a distributed computer network 100 which may incorporate an embodiment of the present invention. Distributed computer network 100 may comprise a plurality of computer systems coupled to a communication network 106 via a plurality of communication links 108. According to an embodiment of the present invention, the computer systems may include one or more user systems 102, a vendor system 112, one or more content provider systems 104, and a shopping services provider system (SSPS) 110. Distributed computer network 100 depicted in FIG. 1 is merely illustrative of an embodiment incorporating the present invention and does not limit the scope of the invention as recited in the claims. One of ordinary skill in the art would recognize other variations, modifications, and alternatives. It should be apparent that a computer system depicted in FIG. 1 may be function as a user system, a vendor system, a SSPS, a content provide system, or combinations thereof.

Communication network 106 provides a mechanism for allowing the various components of computer network 100 to communicate and exchange information with each other. Communication network 106 may itself be comprised of many interconnected computer systems and communication links. Communication links 108 may be hardwire links, optical links, satellite or other wireless communications links, wave propagation links, or any other mechanisms for communication of information. While in one embodiment, communication network 106 is the Internet, in other embodiments, communication network 106 may be any suitable communication network including a local area network (LAN), a wide area network (WAN), a wireless network, a intranet, private networks, public networks, switched networks, and the like. Various communication protocols may be used to facilitate communication between the various systems shown in FIG. 1. These communication protocols may include TCP/IP, HTTP protocols, extensible markup language (XML), wireless application protocol (WAP), IETF, vendor-specific protocols, customized protocols, and others.

In general, unless stated otherwise, the term “user system” may refer to any computer or data-processing system which may be used by a user to access information. For example, the user system may be a cell phone, a personal data assistant (PDA), a laptop, etc. In general, unless stated otherwise, the term “user” may refer to one or more human beings interacting with an user system 102, one or more processes executing on user system 102, systems or devices coupled to a user system 102, and other like entities which may access information via user system 102. In a web environment, user system 102 may be a computing device which a user may use to access information in the form of web pages provided by one or more content providers. For the computer network depicted in FIG. 1, the content providers may include content provider systems 104, vendor systems 112, SSPS 110, other user systems, or other devices/computer systems coupled to communication network 106.

In a web environment, users may generally access web pages using a “browser program” executing on user system 102. In order to access a web page, the user typically provides URL information to the browser, either directly or indirectly, and the browser responds by retrieving the web page corresponding to the URL information, and displaying it to the user on user system 102. While the present invention has been described based on user actions performed in a web environment, it should be apparent that this does not limit the scope of the present invention as recited in the claims. The present invention can be used in various other environments.

A user may also use user system 102 to interact with other computer systems coupled to communication network 106. For example, a user may use user system 102 to participate in online shopping transactions. A user may participate in an online purchase transaction by accessing a web page provided by a content provider system, selecting content information from the web page, and invoking services to shop items related to the selected content information. According to an embodiment of the present invention, the user's purchase request may be communicated to SSPS 110 as an information request. In accordance with the present invention, various other actions performed by a user using user system 102 may also trigger information requests to be communicated to SSPS 110. Further details related to generation of information requests are described below.

The information generated by the present invention in response to information requests may be presented to the user via user systems 102. For example, a user system which triggered an information request may receive information generated by SSPS 110 in response to the information request and provide the information to the user. According to an embodiment of the present invention, the information request may be triggered by a first user system and the information received from SSPS 110 in response to the information request may be presented to the user via a second user system. Further, user system 102 may communicate an information request to SSPS 110 via a first communication channel while the information determined in response to the information request may be received by user system 102 from SSPS 110 via a second communication channel.

A user may also use user system 102 to configure preferences (referred to as “user preferences”) related to user's web browsing and other online activities. For example, a user may configure preferences identifying a user's likes/dislikes and other shopping preferences. Examples of user preferences are discussed in U.S. patent application Ser. No. 09/502,863 (Attorney Docket No. 021790-000800US), entitled “SYSTEM AND METHOD FOR FACILITATING ONLINE SHOPPING ACTIVITIES” filed Feb. 11, 2000, the entire disclosure of which is herein incorporated by reference for all purposes. According to an embodiment of the present invention, the user's preferences may be stored by SSPS 110 and may be used by SSPS 110 to determine information to be provided to the user in response to an information request triggered by the user.

It should be apparent that user system 102 may also be used to perform a variety of other functions and tasks. Various application programs, e.g. a browser program, an email program, a word processor, etc., may execute on user system 102. In a client-server environment, user systems 102 may operate as clients requesting information from server systems coupled to communication network 106 which perform processing in response to the client requests and provide the requested information to the client or user systems. It should however be apparent that a particular user system 102 may act both as a client or a server depending on whether the user system 102 is requesting or providing information. Various types of devices and systems may function as user system 102. These may include a desktop computer, a portable computer, a personal digital assistant, a kiosk, a touch screen display, and other types of data processing devices.

In general, unless stated otherwise, the term “content provider system” may refer to any computer system which provides information which may be accessed via one or more user systems. In a web environment, a content provider system may provide content information which may be published/formatted in the form of web pages stored by content provider system 104. In general, the term “content information” may refer to any type of information or data. For example, content information may include text, images or graphics information, multimedia information, audio information, video information, and other types of information and combinations thereof. Accordingly, in a web environment, the term “content information” may include information displayed or published by the web pages. Vendor systems 112, SSPS 110, and user systems 102 may also function as content provider systems.

In accordance with the present invention, user interactions with one or more web pages provided by a content provider system may trigger an information request to be communicated to SSPS 110. For example, an information request may be automatically generated and communicated from a content provider system 104 to SSPS 110 when a user, using user system 102, accesses a particular web page provided by content provider system 104. Alternatively, an information request may be generated and communicated to SSPS 110 when a user performs some interaction(s) with the particular web page. For example, an information request in the form of a purchase request may be generated when a user accesses a particular web page, selects or identifies content information from the web page, and then select an option to purchase items related to the selected content information. Further details related to the generation and communication of an information request are discussed below.

In general, unless stated otherwise, the term “shopping services provider system” or “SSPS” may refer to any computer system which receives and processes information requests in accordance with the teachings of the present invention. According to an embodiment of the present invention, SSPS 110 may be configured to receive information requests, determine information in response to the information requests, and to communicate the information to the source(s) of the information requests. SSPS 110 may use various rules and preferences to determine the information to be provided in response to the information requests. According to an embodiment of the present invention, the information provided by SSPS 110 to the user in response to one or more information requests triggered by the user's actions enhances the user's online experience. For example, the information provided to the user may simplify and thus enhance the user's ability to perform e-commerce transactions.

According to an embodiment of the present invention, the information to be provided to the user in response to an information request is selected from information provided/configured by one or more vendors. The selection of information may be controlled by rules/preferences configured by the vendors. SSPS 110 may provide various services which allow vendors to specify the information to the provided in response to information requests and to specify rules/preferences which control the conditions and manner in which the information will be provided. For example, SSPS 110 may provide various user interfaces and tools which allow vendors to provide vendor-configured information, specify rules/preferences to be used by SSPS 110, edit existing rules, delete existing rules, and the like. The rules and preference information may be stored by a memory subsystem of SSPS 110 or may be stored in a database coupled to SSPS 110. Alternatively, the information may be stored by other systems coupled to communication network 106 and may be accessed by SSPS 110 when required.

In general, unless stated otherwise, the term “vendor system” may refer to any type of computer system which may be used by vendors. In general, unless stated otherwise, the term “vendor” may refer to sellers, retailers, manufacturers, distributors, merchants, e-commerce participants, and others interested in providing information to a user in response to an information request which may be triggered by the user's actions.

Vendors may use vendor systems 112 to interact with SSPS 110. For example, vendors may use vendor systems 112 to configure information (referred to as “vendor-configured information”) which is to be used by SSPS 110 to determine the information to be provided to the user in response to an information request. Vendors may also use vendor systems 110 to specify rules which may be used by SSPS 110 to determine information to be provided to the user in response to an information request. The vendor-configured information and rules may be stored by SSPS 110. According to alternative embodiments of the present invention, the vendor-configured information and the associated rules may be stored by vendor systems 112 instead of SSPS 110. In these alternative embodiments, a vendor system 112 may receive information related to an information request from SSPS 110, determine information to be provided to the user in response to the information request, and communicate the information to be provided to the user to SSPS 110 to be forwarded to the user. The information may be also directly communicated to a user system by vendor system 112 in alternative embodiments of the present invention.

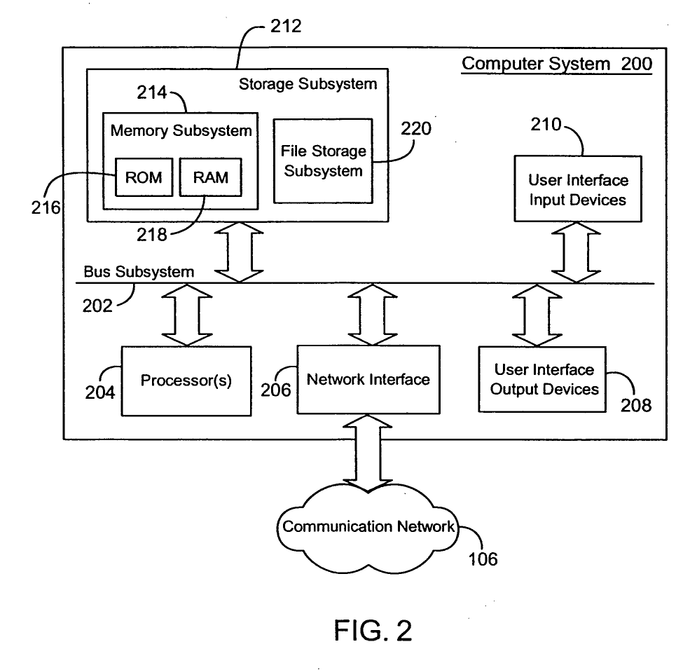

FIG. 2 is a simplified block diagram of an exemplary computer system 200 according to an embodiment of the present invention. Computer system 200 may function as user system 102, as content provider system 104, as vendor system 112, as SSPS 110, or other like system. Computer system 200 typically includes at least one processor 204, which communicates with a number of peripheral devices via bus subsystem 202. These peripheral devices may include a storage subsystem 212, comprising a memory subsystem 214 and a file storage subsystem 220, user interface input devices 210, user interface output devices 208, and a network interface subsystem 206. The input and output devices allow user interaction with computer system 200. It should be apparent that the user may be a human user, a device, a process, another computer, and the like. Network interface subsystem 206 provides an interface to outside networks, including an interface to communication network 106, and is coupled via communication network 106 to corresponding interface devices in other computer systems.

User interface input devices 210 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and ways to input information into computer system 200 or onto communication network 106.

User interface output devices 208 may include a display subsystem, a printer, a fax machine, or non-visual displays such as audio output devices. The display subsystem may be a cathode ray tube (CRT), a flat-panel device such as a liquid crystal display (LCD), or a projection device. The display subsystem may also provide non-visual display such as via audio output devices. In general, use of the term “output device” is intended to include all possible types of devices and ways to output information from computer system 200 to a user or to another machine or computer system.

Storage subsystem 212 stores the basic programming and data constructs that provide the functionality of the computer system. For example, according to an embodiment of the present invention, software modules implementing the functionality of SSPS 110 may be stored in storage subsystem 212 of SSPS 110. These software modules may be executed by processor(s) 204 of SSPS 110. In a distributed environment, the software modules may be stored on a plurality of computer systems and executed by processors of the plurality of computer systems. Storage subsystem 212 also provides a repository for storing the various databases storing information according to the present invention. Storage subsystem 212 typically comprises memory subsystem 214 and file storage subsystem 220.

Memory subsystem 214 typically includes a number of memories including a main random access memory (RAM) 218 for storage of instructions and data during program execution and a read only memory (ROM) 216 in which fixed instructions are stored. File storage subsystem 220 provides persistent (non-volatile) storage for program and data files, and may include a hard disk drive, a floppy disk drive along with associated removable media, a Compact Digital Read Only Memory (CD-ROM) drive, an optical drive, removable media cartridges, and other like storage media. One or more of the drives may be located at remote locations on other connected computers at another site coupled to communication network 106. Information stored according to the teachings of the present invention may also be stored by file storage subsystem 220.

Bus subsystem 202 provides a mechanism for letting the various components and subsystems of computer system 200 communicate with each other as intended. The various subsystems and components of computer system 200 need not be at the same physical location but may be distributed at various locations within distributed network 100. Although bus subsystem 202 is shown schematically as a single bus, alternative embodiments of the bus subsystem may utilize multiple busses.

Computer system 200 itself can be of varying types including a personal computer, a portable computer, a workstation, a computer terminal, a network computer, a mainframe, a kiosk, or any other data processing system. Due to the ever-changing nature of computers and networks, the description of computer system 200 depicted in FIG. 2 is intended only as a specific example for purposes of illustrating the preferred embodiment of the computer system. Many other configurations of a computer system are possible having more or fewer components than the computer system depicted in FIG. 2.

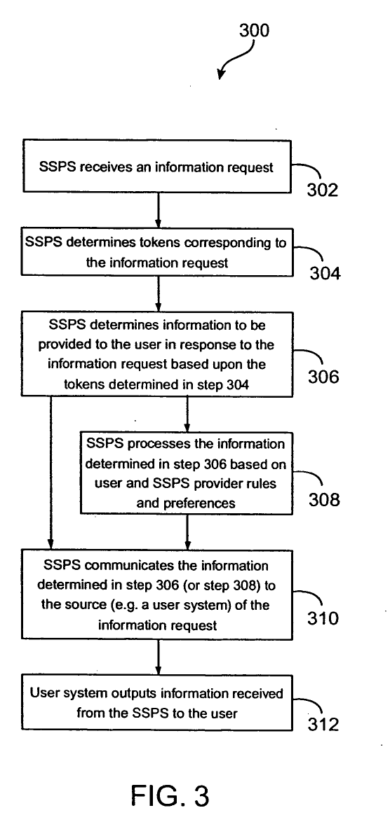

FIG. 3 is a simplified high-level flowchart 300 showing processing performed according to an embodiment of the present invention. As shown in FIG. 3, processing may be initiated when SSPS 110 receives an information request (step 302). The information request may be received from various different sources and/or interfaces and may be triggered by one or more user actions. For example, in a web environment, an information request may be automatically triggered when a user, using user system 102, accesses a particular web pages, when the user configures a purchase request or participates in an e-commerce transaction, when the user invokes services provided by SSPS 110, or upon performing other actions.

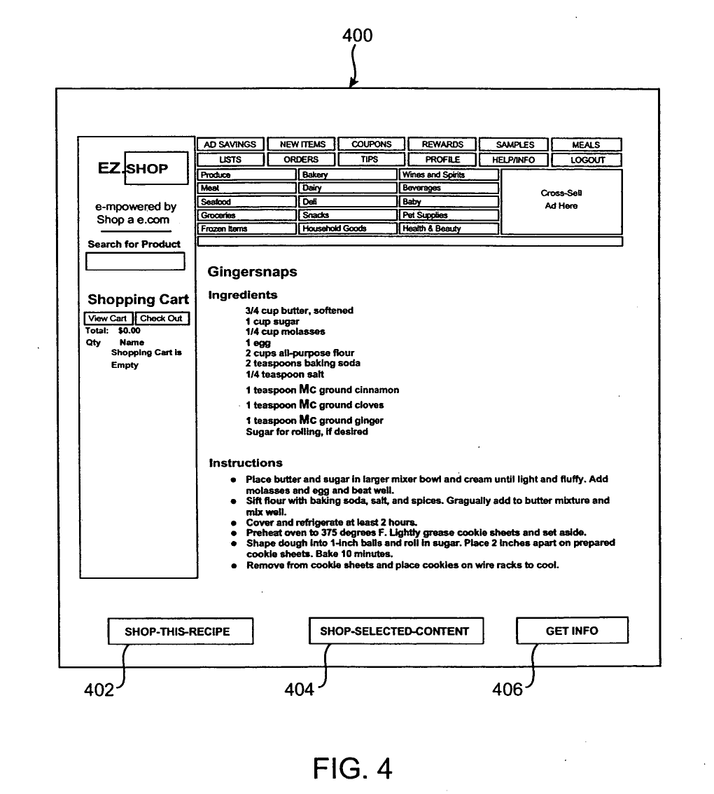

For example, a user may access a web page such as web page 400 depicted in FIG. 4 which displays a recipe for making gingersnaps. According to an embodiment of the present invention, an information request may be generated in response to the user accessing the web page. The information request may then be communicated from content provider system 104 which provides web page 400 to SSPS 110. Various communication protocols known to those skilled in the art may be used to communicate the information request from content provider system 104 to SSPS 110.

According to another embodiment of the present invention, the information request may be generated and communicated to SSPS 110 when the user configures a purchase request. For example, web page 400 may display a user-selectable button 402 (labeled “Shop-This-Recipe”) which when selected may be configured to generate a purchase request for the recipe items. In accordance with the present invention, an information request in the form of a purchase request may be communicated to SSPS 110. User-selectable options may include a button, a menu, a URL, an icon, a banner, and other options which when selected by the user generate a purchase request.

The user may also be allowed to configure a purchase request based upon user-selected portions of the web page contents. The user may use an input device, such as a mouse coupled to user system 102, to select a portion of the web page contents. For example, in FIG. 4, the user may select only the top three items of the recipe (butter, sugar, molasses) and then select a button 404 labeled “Shop-Selected-Content”. In accordance with the present invention, upon selection of button 404, an information request in the form of a purchase request based upon the user-selected contents may be triggered and communicated to SSPS 110.

According to alternative embodiments of the present invention, a user may specifically invoke the services provided by SSPS 110 by causing the generation of an information request. For example, web page 400 may comprise a user-selectable button 406 (labeled “Get Info”) which when selected may be configured to generate an information request based upon the contents of web page 400 or upon user-selected portions of the content. The information request generated upon selection of button 406 may request various types of information related to the contents of web page 400 including branding information, promotional information, suggestive advertising information, purchasable items information, e-commerce information, and the like.

In accordance with the present invention, a user may also invoke services provided by SSPS 110 for content information from web pages which do not provide direct means for generating an information request, e.g. web pages which are not themselves coupled to any module or system for generating information requests. Various techniques may be used to generate information requests for such web pages.

According to a first technique, a user may access a web page provided by SSPS 110, provide information (e.g. URL information) identifying a particular web page(s), and then trigger an information request indicating to SSPS 110 that the user would like to receive information for the contents displayed by the particular web page. According to another technique, the user may copy the contents (or portions thereof) of a web page of interest to the user, and then “paste” the copied content information onto a SSPS-provided web page. The user may then request generation of an information request based upon the “pasted” content information.

Since an information request may be in the form of a purchase request, a user may use the first and second techniques described above to generate purchase requests for web pages which do not support e-commerce transaction processing. It should be apparent that various other techniques may also be used to generate an information request according to the teaching of the present invention.

The information included in an information request received by SSPS 110 may vary depending on the context in which the information request was generated. For example, the information request may comprise information identifying the web page (e.g. URL information) or web site storing the web page from which the information request was triggered. The contents of the web page accessed by the user may also be included in the information request. If the information request is in the form of a purchase request, the information request may contain information related items which the user desires to purchase. For example, for an information request generated in response to selection of buttons 402, 404, or 406 in FIG. 4, the information request may contain information describing the recipe contents displayed by web page 400 or user-selected contents.

An information request may also comprise other information such as a domain name of the web site/page which triggered the request, information associated with the content provider system from which the information request is received, etc. Information about the user, (e.g. user name, user preferences, user contact information, etc.) if available to content provider system 104, may also be included in the information request. Information about user system 102 which was used by the user to access the particular web page may also be included in the information request communicated to SSPS 110. Information about the content provider may also be included in the information request. The content provider information may include for example, branding information related to brands which the content provider wishes to sponsor. Other contextual information related to the user' action(s) which generated the information request may also be included in the information request.

The information request may be received by SSPS 110 in various different forms/formats. For example, according to an embodiment of the present invention, the information request may be received in unstructured “raw” format (e.g. text format). According to alternative embodiments, SSPS 110 may receive a data structure(s) populated by content provider system 104. The level of processing performed by content provider system 104 may vary according to different embodiments of the present invention. According to an embodiment of the present invention, content provider system 104 may even determine tokens related to the contents of the web page (or user-selected contents) and communicate the tokens information to SSPS 110.

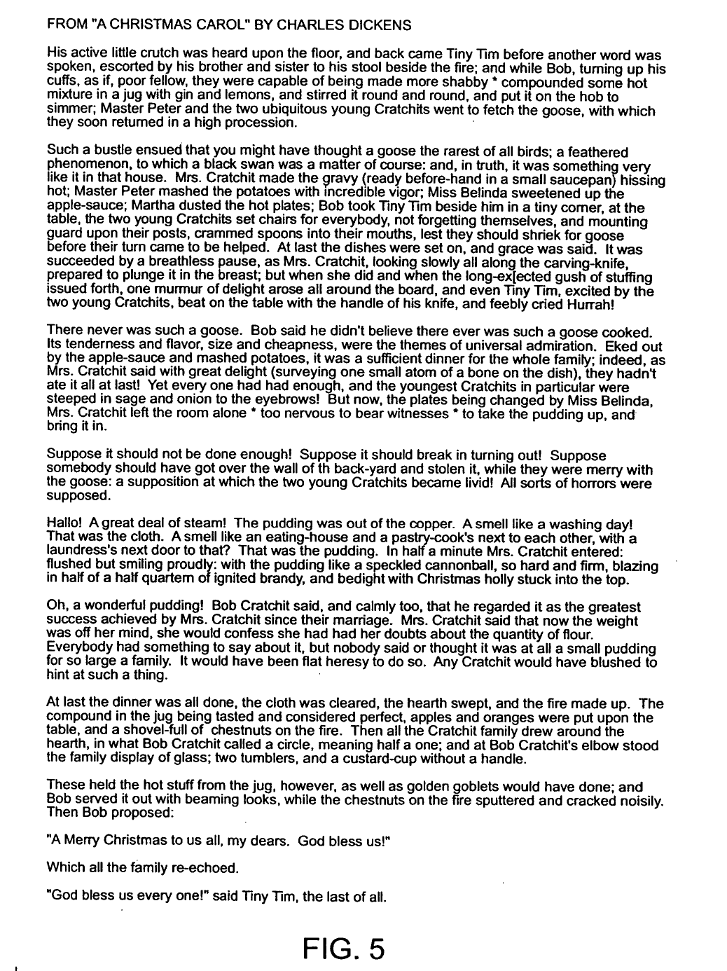

SSPS 110 may then perform processing to determine information to be provided to the user in response to the information request. As part of the processing, SSPS 110 may determine tokens corresponding to the information included in the information request received in step 302 (step 304). The processing performed by SSPS 110 during step 306 may vary depending on the degree of structure of the information included in the information request. For example, the information may be unstructured such as free flowing text (e.g. the text shown in FIG. 5), audio information, video information, and the like, or may include information which is more structured such as a list of items (e.g. a list of ingredients for the gingersnaps recipe depicted in FIG. 4), a set of directions, a list of recommendations, etc. Alternatively, if content provider system 104 has preprocessed the information, the information may be structured in the form of a data structure populated by content provider system 104.

According to an embodiment of the present invention, in order to determine tokens for the information request, SSPS 110 may first extract keywords from the information included in the information request, and then use mapping rules to map or translate the extracted keywords and other information in the information request to tokens For example, as discussed above, the information request may comprise content information displayed by a web page or user-selected portions thereof. As part of step 304, SSPS 110 may parse the content information to extract keywords from the content information. A keyword may be a piece of text, an image, an audio object, a video object, and the like. A particular keyword may be a combination of two of more other keywords, e.g. the word “Abraham” may be a first keyword, the word “Lincoln” may be a second keyword, and the word “Abraham Lincoln” may be a third keyword.

It should be apparent that in alternative embodiments of the present invention, information included in an information request may be mapped directly to tokens without first extracting keywords from the information included in the information request. For example, if the information request contains URL information identifying a particular web page, SSPS 110 may directly determine tokens corresponding to the URL. Such mapping information may be stored by SSPS 110.

SSPS 110 may use various techniques for extracting keywords from the content information included in the information request. A first extraction technique may use a list of keywords stored by SSPS 110 to facilitate the keyword extraction. The keywords in the list may be configured by providers of SSPS 110 or may alternatively be provided/configured by one or more vendors. Keywords provided by vendors may generally identify elements of particular interest to the vendors. For example, a vendor who sells diapers of “Brand X” may indicate that “Brand X” and “diapers” be included as two separate keywords in the keywords list. According to the first extraction technique, SSPS 110 may parse the information included in the information request to extract or identify keywords which match keywords in the list of keywords.

According to another technique, keywords may be extracted based upon tags/attributes associated with the keywords in the content information included in the information request. The tags may convey attribute special meaning to the keywords. For example, SSPS 110 may extract all words from the content information which have been bolded or underlined or italicized, etc. The keywords extracted from the content information may be stored by SSPS 110 for further processing.

According to an embodiment of the present invention, SSPS 110 may extract keywords describing: one or more items described by the information request (e.g. items which the user wishes to purchase such as “1 egg”, branding information related to the item(s) (e.g. milk of a specific Brand Y), information related to other attributes of the items (e.g. brown sugar, skimmed milk), information related to the user (e.g. name of the user, age of the user, geographical location of the user, the user's preferences or affiliations), information related to a user's shopping preferences (e.g. if the user prefers low-fat milk (as indicated by the user preferences)), information related to content providers, and other like information.

As an example, the following keywords may be extracted by SSPS 110 from the content information depicted in FIG. 5 according to an embodiment of the present invention.

Keywords=(stool, jug, gin, lemons, goose, gravy, saucepan, potatoes, apple-sauce, plates, chairs, spoons, dishes, carving knife, stuffing, board, knife, sage, onion, pudding, cloth, brandy, Christmas holly, apples, oranges, shovel, chestnuts, glass, tumblers, custard cups)

As part of the content analysis, SSPS 110 may also extract quantities, if any, associated with the keywords. For example, if the information request was a purchase request for ingredients for a recipe (such as information depicted in FIG. 4), quantities associated with each ingredient may be extracted and associated with the corresponding keywords. SSPS 110 may also extract the unit of measure, where applicable, for each quantity, e.g. grams, liters, gallons, teaspoon, a pinch, etc. For example, for the content information depicted in FIG. 4, SSPS 110 may extract the keyword “sugar” and associate a quantity “1” and a unit of measure “cup” with the keyword.

According to an embodiment of the present invention, as part of step 304, SSPS 110 may also determine information related to one or more “projects” described by the content information in the information request. In general, unless stated otherwise, the term “project” may refer to a particular task, activity, or undertaking of interest to a user which may involve materials, tools, directions, and the like. Examples of projects include a recipe for preparing a food dish (e.g. the recipe for preparing gingersnaps depicted in FIG. 4), building a computer, building a house, repairing a faucet, preparing Christmas dinner as described by Charles Dickens in “A Christmas Carol” (as depicted in FIG. 5), and the like.

According to an embodiment of the present invention, the information request received by SSPS 110 may contain information related to one or more projects. For example, an information request generated in response to selecting “Get Info” button 406 depicted in FIG. 4 may contain information related to the recipe (project) for preparing gingersnaps. An information request may contain information related to one or more projects including information describing items related to the projects (e.g. ingredients of a recipe, etc.).

According to an embodiment of the present invention, the information included in the information request may comprise an identifier uniquely identifying a project (a “project identifier”) or description related to the project. If the information comprises a project identifier, SSPS 110 may be configured to map the project identifier to one or more tokens based upon “project identifier to tokens” mapping information which may be stored by SSPS 110.

If the information request comprises information describing a project, as part of step 304, SSPS 110 may process the project related information included in the information request to identify one or more different projects and keywords associated with the one or more projects. The keywords for each project may correspond to items related to the project, quantities and units of measure associated with the items, directions for the project, and the like.

As part of step 304, SSPS 110 may also determine contextual information based upon the projects related information extracted from the information request. For example, if the content information describes two projects—a first project related to cooking a turkey and a second project related to preparing cranberry sauce, SSPS 110 may determine that the user is preparing a “Thanksgiving Meal.” Rules for making such deductions/inferences may be stored by SSPS 110. Further information related to processing of content information for projects is described in U.S. patent application Ser. No. 09/780,987 (Attorney Docket No. 021790-000720US) filed concurrently with this application, the entire disclosure of which is herein incorporated by reference for all purposes.

As part of step 304, SSPS 110 may also extract keywords related to other information which may be included in the information request such as domain name information of the web site/page which triggered the information request, information associated with the content provider system from which the information request is received, information about the user (e.g. user name, user preferences, user contact information, etc.), information about user system 102 which was used by the user to access the particular web page and which triggered the information request, information about the content provider such as branding information related to brands which the content provider wishes to sponsor, and the like.

After extracting keywords from information included in the information request, SSPS 110 may then determine one or more “tokens” corresponding to the keywords and the extracted information. In general, unless stated otherwise, the term “token” may refer to a word, a combination of words, an image, a keyword, an audio object, a video object, a combination of other tokens, and the like. In accordance with the present invention, tokens are used to encapsulate information related to the information request and to convey the information to the vendors such that the vendors do not have to know about the information included in the information request. Tokens thus provide a level of indirection and act as intermediaries between the content information accessed/selected by a user and the vendors. In this manner, the vendors are de-coupled from the actual contents of the web pages which were accessed by the user and which generated the information request. Tokens thus insulate vendors from the ever changing content and format of web pages selected/accessed by the user. Due to their persistent nature, tokens provide a convenient interface to organize, analyze, and use information received in the information request. Tokens may be used by a vendor to identify if a particular information request comprises information which may be of interest to the vendor. In accordance with the present invention, tokens may be specified by vendors or by providers of SSPS 110.

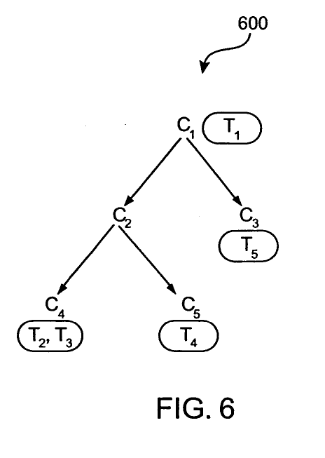

According to an embodiment of the present invention, each token may be classified as belonging to a particular category. Categories may be used to group or organize the tokens. For example, the tokens “chocolate” and “milk” may be classified as belonging to the category “dairy products.” Several categories may be defined either by the vendors or providers of SSPS 110. Hierarchical relationships allowing for multiple inheritance may be established between the categories. For example, FIG. 6 depicts a category hierarchy according to an embodiment of the present invention. Five categories, namely “C₁”, “C₂”, “C₃”, “C₄”, and “C₅”, have been defined for the embodiment depicted in FIG. 6. FIG. 6 also depicts tokens “T₁”, “T₂”, “T₃”, “T₄” and “T₅” associated with the various categories. For example, token “T₁” is categorized as belonging to category “C₁”, tokens “T₂” and “T₃” are associated with category “C₄”, token “T₄” is associated with category “C₅”, and token “T₅” is associated with category “T₅.” The hierarchical relationships between the categories may be defined such that a token belonging to a particular category is also deemed to belong to all parent categories of the particular category (i.e. a category inherits from all its parent categories). For example, tokens “T₂” and “T₃” belonging to category “C₄” are also deemed to belong to categories “C₂” and “C₁.” Likewise, token “T₄” associated with category “C₅” is also deemed to belong to categories “C₂” and “C₁”, and token “T₅” belonging to category “C₃” is also deemed to belong to category “C₁.” A particular category may also inherit from more than one category (multiple inheritance). It should be apparent that various other types of categories and relationships between the categories may be defined according to other embodiments of the present invention.

In accordance with the present invention, in step 304, keywords and other information included in the information request may be mapped to one or more tokens. For example, a keyword “milk” may translate to a single token “milk” (1-to-1 mapping, wherein the token and the keyword may be the same). Alternatively, a keyword may map to a plurality of tokens (e.g. a keyword may map to tokens which are synonyms of the keyword) For example, the keyword “milk” may map to several tokens including a token “milk”, a token “dairy products” indicating the category of the item, one or more tokens related to milk product brand names, tokens related to products complementary to milk (e.g. cookies), and the like (1-to-many mapping). A plurality of keywords or pieces of information may also map to a single token (many-to-1 mapping). For example, keywords “turkey”, and “cranberry sauce” extracted from the user-selected content information may map to a single token representing “Thanksgiving dinner”. A plurality of keywords or pieces of information may also map to a plurality of tokens (many-to-many mapping). Where applicable, quantity information and unit of measure information associated with a keyword may also be associated with the token(s) corresponding to the keyword.

According to an embodiment of the present invention, the mapping of keywords and information included in an information request to tokens may be based upon rules (referred to as “token mapping rules”) which may be stored by SSPS 110. Token mapping rules may be configured by the vendor(s) or by providers of SSPS 110. These rules may specify the 1-to-1, or 1-to-many, or many-to-1, or many-to-many mappings of keywords to tokens. Token mapping rules may also specify how information related to an information request gets mapped to tokens. As part of step 304, after determining keywords corresponding to the information request, SSPS 110 may apply the token mapping rules to determine tokens corresponding to the keywords and other information related to the information request.

According to an embodiment of the present invention, the token mapping rules may be stored in the form of a table as shown below in Table 1.

TABLE 1
Token Mapping Rules

| Token | | |
|---|---|---|
| Mapping Rule | Keywords/Other Info | Tokens |
| 1 | K₁ | T₁ |
| 2 | K₁ + K₂ | T₂ |
| 3 | K₃ | T₃, T₄ |
| 4 | K₃ + K₄ + K₅ | T₅, T₅ |
| 5 | K₃ + “Specific User Info” | T₇ |

As shown above, each row in Table 1 identifies a token mapping rule. For example, Rule #1 indicates that a keyword “K₁” maps to token “T₁” (1-to-1 mapping). Rule #2 indicates that the presence of both keywords “K₁” and “K₂” maps to a token “T₂” (many-to-1 mapping). According to Rule #3, a keyword “K₃” maps to tokens “T₃” and “T₄” (1-to-many mapping). According to Rule #4, tokens “T₅” and “T₆” are set if keywords “K₃”, “K4”, and “K₅” are present (many-to-many mapping). According to Rule #5, a token “T₂” is set if keyword “K₃” and a specific user information is present in the information request. Rule #5 illustrates how keywords and information included in the information request may be used in conjunction to map to a token. Several other rules may also be configured in accordance with the present invention.

The token mapping rules examples shown in Table 1 are merely illustrative of an embodiment incorporating the present invention and are not meant to limit the scope of the invention as recited in the claims. One of ordinary skill in the art would recognize other variations, modifications, and alternatives.

As indicated above, the token mapping rules may be configured by one or more vendors or by providers of SSPS 110. Accordingly, as discussed above, as part of the processing performed in step 308, SSPS 110 may apply the token mapping rules to the keywords and other information related to the information request and determine tokens corresponding to the information request.

Referring back to FIG. 3, after tokens corresponding to the information request have been determined for the information request according to step 304, SSPS 110 may then determine information to be provided to the user in response to the information request based upon the tokens determined in step 304 (step 306). Various different techniques may be employed by SSPS 110 to determine the information to be provided to the user. In accordance with the teachings of the present invention, SSPS 110 may determine the information based upon rules (may be referred to as “token-to-information mapping” rules) which indicate information to be provided to the user when certain tokens or categories of tokens are set (or determined in step 304). Each token-to-information mapping rule may identify one or more tokens or token categories and associated information to be provided to the user. These rules may be configured by vendors or by providers of SSPS 110.

According to an embodiment of the present invention, the token-to-information rules may be stored by SSPS 110 and may identify mappings between one or more tokens and information to be provided to the user. The token-to-information mapping rules may also identify information to be provided to the user based on categories associated with the tokens. Based on the tokens and token categories determined in step 304, SSPS 110 may apply the token-to-information rules to identify information to be provided to the user.

For example, if the information request was in the form of a purchase request configured by the user, the information determined in step 306 may include information related to purchasable items satisfying the user's purchase request. The term “purchasable item” as used in this application refers to any item (good or services) which can be purchased by a user. For each purchasable item, the information may comprise information identifying the purchasable item, brand name of the purchasable item, price of the purchasable item, quantity of the purchasable item, and other like information related to the purchasable item. Each purchasable item may be identified by a unique identifier such as an industry standard UPC, EAN, or PLU product code. For example, a purchase request requesting the purchase of “butter” may map to several purchasable items including butters of a specific size manufactured by Land O'Lakes (e.g. Land O'Lakes Butter, salted, 16 oz.), Challenge (e.g. Challenge Butter Grade AA, 16 oz.), and other butter manufacturers. The information provided to the user may also include marketing information, promotional information, suggestive advertising information, branding information, information related to items which are complementary to items in the user's purchase request, information related to substitute items, recommendation information, branding information, and other like information.

According to an embodiment of the present invention, the token-to-information mapping rules may be stored by SSPS 110 in a table such as Table 2 shown below:

TABLE 2
Token-to-information Mapping rules

| Token-to-information | | Info to be provided to the |
|---|---|---|
| Mapping Rule | Tokens | user |
| 1 | T₁ | I₁ |
| 2 | T₁ +T₂ | I₁, I₂, I₃ |
| 3 | (T₁ + T₂) ∥ (T₁ + T₃) | I₄ |
| 4 | T₄ ∥T₅ | I₅ |
| 5 | Category “C2” | I₆ |

As shown above, each row in Table 2 identifies a token-to-information mapping rule. For example, Rule #1 indicates that if token “T₁” has been determined in step 304, information “I₁” should be provided to the user in response to the information request. Rule #2 indicates information “I₁”, “I₂”, and “I₃” are to be provided to the user if tokens “T₁” and “T₂” have been determined in step 304. Rule #3 indicates that information “I₄” is to be provided to the user if either tokens “T₁” and “T₂” or tokens “T₁” and “T₃” have been determined in step 304. Rule #4 indicates that information “I₅”, is to be provided to the user if tokens “T₄” or “T₅” have been determined in step 304. As discussed above, token-to-information mapping rules may also be associated with one or more categories associated with the tokens. For example, Rule #5 indicates that information “I₆” is to be provided to the user if any token associated with category “C₂” is determined in step 304 (e.g. for the category hierarchy depicted in FIG. 6, “I₆” is to be provided to the user if any of tokens “T₂”, “T₃”, and “T₄” are determined in step 304) Several other rules may also be configured in accordance with the present invention. As indicated above, the token-to-information mapping rules may be configured by one or more vendors or by the providers of SSPS 110.

As part of step 306, given a set of token-to-information rules, such as the rules depicted in Table 2, SSPS 110 may determine a subset of the rules which apply to the information request based upon the tokens corresponding to the information request determined in step 304. SSPS 110 may then apply the subset of rules to determine information which is to be provided to the user in response to the information request. Processing may then proceed with step 308 or step 310.

In alternate embodiments of the present invention, instead of mapping the tokens directly to information to be provided to the user (like in Table 2), the token-to-information mapping rules may identify vendors who are “interested” in one or more tokens or token categories (i.e. the token-to-information mapping rules may map tokens and their categories to vendors). For each vendor, the token-to-information mapping rules may then identify information configured by the particular vendor which is to be provided to the user. Accordingly, using the token-to-information rules, SSPS 110 may first determine the vendors whose information is to be provided to the user in response to the information request and then determine the information configured by the vendors to be provided to the user.

For example, the token-to-information mapping rules may be stored in a table such as Table 3 shown below:

TABLE 3
Token-to-information Mapping rules

| Token-to- | | | |
|---|---|---|---|
| information | | | |
| Mapping Rules | Tokens | Vendor | Vendor info to be provided to the user |
| 1 | T₁, T₂ | V₁ | T₁ → V₁I₁ |
| | | | (T₁ + T₂) → V₁I₂ |
| 2 | T₁, T₂, T₃ | V₂ | (T₁ +T₂) ∥ (T₁ + T₃) → V₂I₁ |
| 3 | T₄, T₅ | V₃ | T₄ ∥ T₅ → V₃I₁ |
| 4 | Category “C2” | V₄ | T₂ → V₄I₁ |
| | | | (T₃ + T₄) → V₄I₂ |
| | | | Category “C₂” → V₄I₃ |

As shown above, each row in Table 2 identifies a token-to-information mapping rule. The second column of the table identifies tokens or categories of the tokens which are of interest to a particular vendor identified in the third column of the table. For each vendor identified in the third column, the fourth column of the table identifies vendor configured-information to be provided to the user based on one or more tokens and token categories of interest to that vendor. For example, Rule #1 indicates that vendor “V₁” is interested in tokens “T₁” and “T₂”. The rule further indicates that information “V₁I₁” (information “I₁” provided by vendor “V₁”) is to be provided to the user if token “T₁” is set (i.e. determined in step 304) and information “V₁I₂” is to be provided to the user if both tokens “T₁” and “T₂” are set. Rule #2 indicates that vendor “V₂” is interested in tokens “T₁”, “T₂”, and “T₃”. The rule further indicates that information “V₂I₁” is to be provided to the user if tokens (“T₁” and “T₂”) or tokens (“T₁” and “T₃”) are set. Rule #3 indicates that vendor “V₃” is interested in tokens “T₄” and “T₅”. The rule further indicates that information “V₃I₁” is to be provided to the user if either of the tokens “T₄” or “T5” are set. Rule #4 indicates that vendor “V₄” is interested in all tokens belonging to the category “C₂” (which implies tokens “T₂”, “T₃”, and “T₄” for the category hierarchy depicted in FIG. 6). The rule further indicates that information “V₄I₁” is to be provided to the user if token “T₂” is set, information “V₄I₂” is to be provided to the user if tokens (“T₃” and “T₄”) are set, and information “V₄I₃” is to be provided to the user if any tokens belonging to category “C₂” are set. Various other token-to-information mapping rules may also be defined.

The token-to-mapping rules examples shown in Tables 2 and 3 are merely illustrative of an embodiment incorporating the present invention and are not meant to limit the scope of the invention as recited in the claims. One of ordinary skill in the art would recognize other variations, modifications, and alternatives.

According to an embodiment of the present invention, the vendor-configured information to be provided to the user may be stored by SSPS 110 or by vendor systems 112. In embodiments of the present invention where the information is stored by vendor systems 112, SSPS 110 may forward information related to the tokens to vendor systems 112 corresponding to the interested vendors. Vendor systems 112 may then perform token-to-information information mapping rules stored by vendors systems 112 to determine information to be provided to the user in response to the token information provided by SSPS 110. For example, vendor systems 112 may perform processing to apply the rules set forth in the fourth column of Table 3 The information determined by vendor systems 112 may then be communicated from vendor systems 112 to SSPS 110 for further processing. It should be apparent that various other mechanisms may also be used by the present invention to determine information to be provided to the user in response to an information request triggered by the user's actions.

Referring back to FIG. 3, SSPS 110 may then communicate the information determined in step 306 to the source of the information request e.g. to user system 102 (step 310). According to an embodiment of the present invention, SSPS 110 may receive the information request from a first computer system and the information determined by SSPS 110 in response to the information request may be communicated to a second computer system. According to alternative embodiments of the present invention, the information request may be received by SSPS 110 via a first communication channel while the information determined in response to the information request may be communicated by SSPS 110 to the user via a second communication channel. User system 102 may then output the information received from SSPS 110 to the user (step 312).

Depending on the nature of the information request, the information determined by SSPS 110 to be provided to a user in response to the information request may include: promotional information, marketing information, branding information, advertising information, suggestive selling information, information related to purchasable items which can be purchased by the user, and the like. The branding information may include a vendor name, a brand name, branded artwork, images, trademarks or logos, a URL identifying a brand company web site or web page, product name or catalog information, and the like.

According to alternative embodiments of the present invention, SSPS 110 may further process the information determined in step 306 based upon user preferences and rules or preferences configured by providers of SSPS 110 (step 308). The processing performed in step 308 may include selecting information from the information determined in step 306 to be communicated to the user system, modifying the information determined in step 306, augmenting the information determined in step 306 with additional information, formatting the information determined in step 306, indicating the manner in which the information is to be presented to the user, and the like. As part of step 308, the information determined in step 306 may be processed based upon vendor configured rules/preferences.

As discussed in U.S. patent application Ser. No. 09/502,863 (Attorney Docket No. 021790-000800US), entitled “SYSTEM AND METHOD FOR FACILITATING ONLINE SHOPPING ACTIVITIES” filed Feb. 11, 2000, several user preferences may be specified or configured related to the user's online activities, e.g. a user may configure preferences related to items purchased by the user. As part of the processing performed in step 308, SSPS 110 may filter the information determined in step 306 such that the information communicated to the source of the information request only includes information which satisfies the user preferences. For example, in response to a purchase request, the information determined in step 306 may include purchasable items information related to an item of Brand X and Brand Y. However, if the user preferences indicate that the user prefers to buy items of Brand X only, then information related to the Brand Y item may be filtered from the information communicated to user system 110.

SSPS 110 may also process the information determined in step 306 based upon rules or preferences configured by providers of SSPS 110. These rules or preferences may include e-marketing rules, priority rules, branding rules, and the like. For example, these rules may indicate that certain vendors be preferred over other vendors, certain brands be preferred over other brands, certain items be preferred over other items, and the like. For example, a particular SSPS provider configured rule may specify that for a particular token “Tₙ”, only information from vendor “Vₙ” is to be forwarded to the user, even though the information determined in step 306 in association with token “Tₙ” may contain information from other vendors. In applying this rule, SSPS 110 may filter out all information from the other vendors before communicating the information to user system 102 according to step 310. In this manner, providers of SSPS 110 may allow a vendor to have exclusive rights or special rights to one or more tokens. Rules may also be specified which allow providers of SSPS 110 to “rent” out one or more tokens to one or more vendors for a specific period of time, such that during the specific period of time information from only those vendors who have “rented” the token(s) is communicated to user system 102. Rules may also be specified related to the frequency of use of the tokens. Various other rules may also be configured in accordance with the present invention.

Rules may also be defined to specify the manner in which the information is to be presented to the user (e.g. presentation list rules). For example, items from a “preferred” vendor may be presented to user in a special manner with the appropriate web page geometry. SSPS 110 may accordingly format the information to be communicated to user system 102 to comply with the presentation rules. Further details related to presentation lists are discussed in U.S. patent application Ser. No. 09/502,863 (Attorney Docket No. 021790-000800US), entitled “SYSTEM AND METHOD FOR FACILITATING ONLINE SHOPPING ACTIVITIES” filed Feb. 11, 2000, the entire disclosure of which is herein incorporated by reference for all purposes.

Accordingly, as part of step 308, SSPS 110 may apply rules or preferences configured by the user or by providers of SSPS 110 to determine information which is to be communicated to user system 102. The filtered or modified or reformatted information may then be communicated to user system 102 according to step 314. As discussed above, the information communicated to user system 102 may include marketing information, promotional information, suggestive advertising information, purchasable items information, information related to items which are complementary to items in the user's purchase request, information related to substitute items, recommendation information, information related to e-commerce sites, and other like information.

User system 102 may then present the information to the user (step 312). User system 102 may use various different techniques to present the information received from SSPS 110 to the user. For example, if the information included purchasable items information generated in response to a purchase request, a presentation list of purchasable items may be displayed to the user by user system 102. User system 102 may use various interfaces to provide information received from SSPS 110 to the user. Other output devices coupled to user system 102 may also be used to present the information to the user. U.S. patent application Ser. No. 09/502,863 (Attorney Docket No. 021790-000800US), entitled “SYSTEM AND METHOD FOR FACILITATING ONLINE SHOPPING ACTIVITIES” filed Feb. 11, 2000, discusses examples of user interfaces which maybe used to provide information to the user.

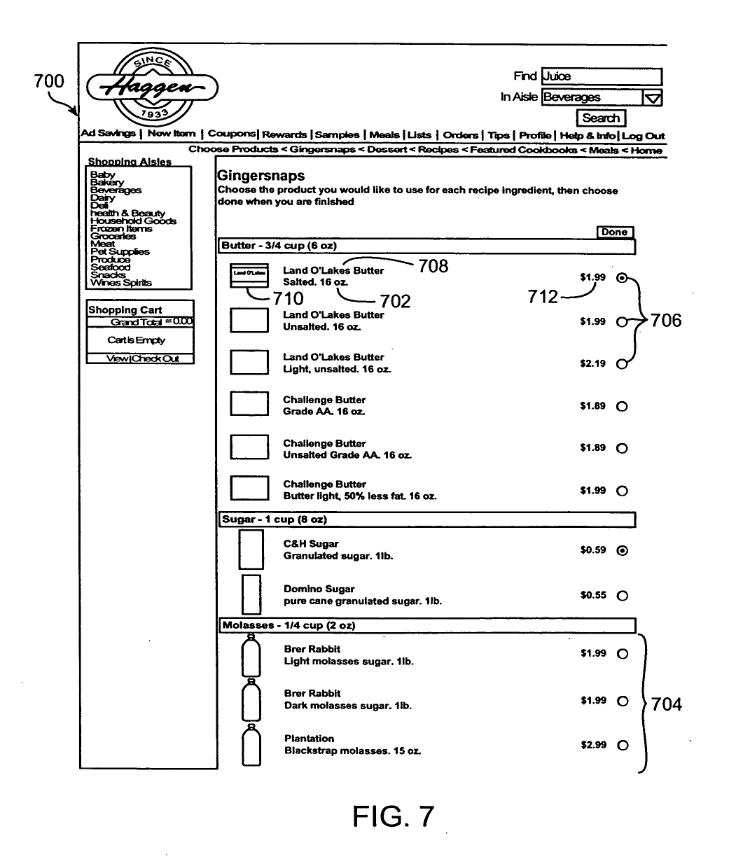

According to an embodiment of the present invention, user interface 700 depicted in FIG. 7 may be used for displaying information received from SSPS 110 to the user. The information displayed in FIG. 7 may be determined by SSPS 110 in response to an information request embodying a purchase request configured by the user by selecting the top three items of the recipe (i.e. content information related to butter, sugar, molasses) depicted in FIG. 4 and selecting “Shop-Selected-Content” button 404. As depicted in FIG. 7, the information presented to the user includes information about purchasable items for butter, sugar, and molasses. For each purchasable item, the displayed information specifies the brand name 708 of the purchasable item, the quantity 702 of the purchasable item, a graphical image of the purchasable item 710, and a price 712 associated with the purchasable item.

The information displayed in user interface 700 may be customized for the user based on the user's preferences information. For example, the user preferences may indicate a lowest price preference, and also a brand preference for Land O'Lakes butter and C&H sugar. Accordingly, the purchasable items 704 for molasses are listed in ascending price order. However, since the user has specifically indicated a brand preference for butter and sugar, information related to purchasable items belonging to the user's preferred brands (Land O'Lakes butter and C&H sugar) are listed higher up in presentation lists for butter and sugar. The information is also ordered based on the pricing information for the other items. User interface 700 also displays radio buttons 706 which allow the user to select one or more of items for purchase. Various other user interfaces options such as banners, URLs, sidebars, pop-up menus, streaming media, etc. may also be used to display the information received from SSPS 110.

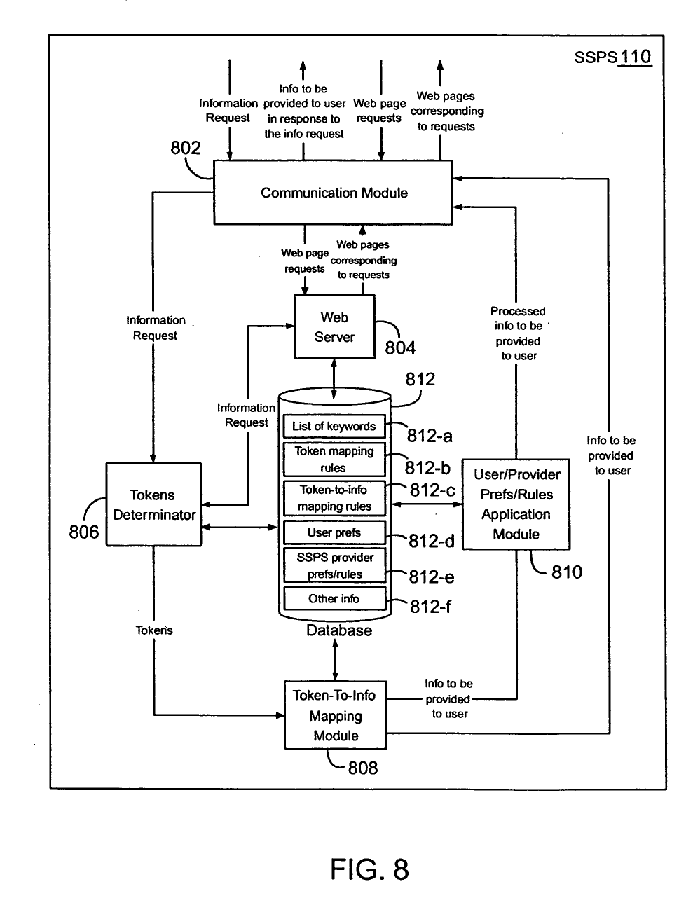

FIG. 8 is a simplified block diagram showing the various modules/engines of SSPS 110 which may be used to process an information request and provide information to the user in response to the information request according to an embodiment of the present invention. The modules depicted in FIG. 8 may be implemented in software or hardware or combinations thereof. As shown in FIG. 8, the modules may include a communication module 802, a web server 804, a tokens determinator module 806, a token-to-information mapping module 808, a user/provider preferences/rules application module 810, and database 812.

Communication module 802 may be configured to facilitate communication of information and data to and from SSPS 110. In the inbound direction, communication module 802 may receive an information request. As discussed above, the information request may comprise information related to a web page accessed by a user, user-selected content information, purchase request information, and the like. Communication module 802 may forward the information request to tokens determinator module 806 for further processing. In the outbound direction, communication module 802 may communicate information determined by SSPS 110 in response to the information request to the source of the information request, e.g. to user system 102. Communication module 802 may also receive web page requests from one or more computer systems coupled to SSPS 110. Communication module 802 may be configured to forward the web page requests to web server 804, receive web pages from web server 804 in response to the requests, and communicate the web pages to the requesting computer systems. According to an embodiment of the present invention, communication module 802 performs processing performed in steps 302 and 310 in FIG. 3.

Web server 804 may be configured to store one or more web pages provided by SSPS 110. Web server 804 may receive web page requests, determine web pages corresponding to the requests, and forward the web pages to communication module 802 for communication to the requesting computer systems. As indicated above, the scope of the present invention however is not limited to a web environment. For example, the teachings of the present invention may be incorporated in a client-sever environment, a wireless environment, any network environment, etc.

Tokens determinator module 806 may be configured to determine tokens corresponding to the information requests. In order to determine the tokens, tokens determinator module 806 may be configured to extract keywords and other information from the information request, and then determine tokens for the extracted keywords and information. According to an embodiment of the present invention, tokens determinator module 806 may use a list of keywords 812-a stored in database 812 to facilitate extraction of keywords from information included in the information request. Tokens determinator module 806 may use token mapping rules 812-b to map the keywords and other information in the information request to tokens. The tokens determined by tokens determinator module 806 may then be forwarded to token-to-information mapping module 808 for further processing. According to an embodiment of the present invention, tokens determinator module 806 performs processing performed in step 304 in FIG. 3.

Token-to-information mapping module 808 may be configured to determine information to be provided to the user based on tokens received from tokens determinator module 806. Token-to-information mapping module 808 may use token-to-information mapping rules 812-c stored in database 812 to determine the information to be provided to the user in response to the information request. According to an embodiment of the present invention, token-to-information mapping module 808 performs processing performed in step 306 in FIG. 3.

According to an embodiment of the present invention, the information determined by token-to-information mapping module 808 may be forwarded to communication module 802 for communication to user system 102. According to an alternative embodiment of the present invention, token-to-information mapping module 808 may forward the information to user/provider preferences/rules application module 810 for further processing.

User/provider preferences/rules application module 810 may be configured to further process the information received from token-to-information module 808 to determine information to be communicated to user system 102. The processing performed by user/provider preferences/rules application module 810 may be based on user preferences 812-d and/or SSPS provider rules/preferences 812-e which may be stored in database 812. In alternative embodiments of the present invention, user/provider preferences/rules application module 810 may be configured to process the information received from token-to-information module 808 based upon rules/preferences configured by the vendors. According to an embodiment of the present invention, user/provider preferences/rules application module 810 performs processing performed in step 308 in FIG. 3. The information processed by user/provider preferences/rules application module 810 may then be forwarded to communication module 802 for communication to user system 102.

Database 812 may serve as a repository for storing information related to processing performed by SSPS 110. For example, list of keywords 812-a, token mapping rules 812-b, token-to-information mapping rules 812-c, user preferences 812-d, SSPS provider preferences/rules 812-e, and other information 812-f may be stored in database 812. Further, information/data output by a module of SSPS 110 may be stored in database 812 before being forwarded to another module for further processing.

As discussed above, the present invention provides a dynamically configurable system which allows vendors to provide information to users in seamless and integrated manner. Tokens act as intermediaries between the content information accessed/selected by a user and the vendors. The vendors are de-coupled from the actual contents of the web pages accessed by the user and are thus insulated from the ever changing content and format of web pages accessed by a user. The de-coupling also enables vendors to change their business rules/logic, add new vendor information, emphasize seasonal merchandise, etc. in a manner which is not dependent on the content information provided by the user. Due to their persistent nature, tokens provide a convenient interface which can be used by a vendor to identify if and when information included by an information request is of interest to the vendor and to configure information to be provided to the user in response to the information request. Token-to-information mapping rules configured by a vendor may be tailored to achieve the vendors' goals and to influence the user's shopping behavior. The present invention thus provides vendors a cost-effective way to effectively target potential customers.

According to an embodiment of the present invention, the present invention may be used by vendors to provide information related to purchasable items in response to a user purchase request. The present invention makes it possible for a user to purchase items described by content information published by web sites/pages which do not provide any e-commerce purchasing services. Such a feature is not provided by conventional online shopping systems. Accordingly, the present invention can be used in conjunction with any system which provides content information which can be selected by a user. For example, in an interactive television environment, the user may select a particular television program, and configure a purchase request to buy items related to the selected television program (e.g. a purchase request to buy swimsuits featured in a particular episode of the television program “Baywatch”). The present invention may then automatically provide purchasable items information and other promotional information to the user in response to the purchase request. The present invention thus offers a level of online shopping convenience and flexibility heretofore not provided by conventional online shopping systems. The overall online shopping experience of a user is thus enhanced.

Features of the present invention thus include the distribution of information to users according to the context for both promotion and project information established by the relationships structured through the token index. In this way, content (which can be text, audio, video, graphics, etc. and combinations thereof) can be associated with promotions and vendor information available via the network. Moreover, because the tokens provide indirection between the content viewed by the reader and the promotion or project information to be displayed by the vendor, the tokens may be programmed and reconfigured separate from the original content being viewed by the user or the vendor's e-commerce information. This permits users to view content not heretofore tied into vendor purchase and information systems to be directed into e-commerce, thus, Transactive Content™ is created. These capabilities are embodied in the “Transactive Content”™ e-commerce system and “Contextual E-Commerce”™ services provided by ShopEaze Systems, Inc.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments, such as a distributed computer network environment, a single stand-alone computer system environment, or other computing environments. Additionally, although the present invention has been described using a particular series of transactions and steps, it should be apparent to those skilled in the art that the scope of the present invention is not limited to the described series of transactions and steps.

The data structures for the storage and processing of the various rules according to the teachings of the present invention may be stored in tables in a relational database. However, other forms of storing the information may also be used. There is inherent flexibility in creating the logic, system flow, and data structures necessary to program the invention. Data structures and values upon which calculations are performed may be explicit, derived from other data, imported from other sources, or result from program calculations or logical operations, all without departing from the spirit or limiting the scope of the invention. The steps and processes for indexing, searching, and data processing in this application may be substituted or modified to support various performance and/or systems integration requirements, without deviating from the invention.

Further, while the present invention has been described using a particular combination of hardware and software, it should be recognized that other combinations of hardware and software are also within the scope of the present invention. The present invention may be implemented only in hardware or only in software or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. In a network comprising a plurality of computers, a computer-implemented method of providing information in response to an information request, the method comprising:
providing a first set of rules identifying a plurality of tokens and information associated with the plurality of tokens;
receiving the information request from a first source, the information request generated in response to an action performed by the user;
determining a first set of tokens from the plurality of tokens corresponding to the information request;
determining first information corresponding to the first set of tokens based upon the first set of rules; and
communicating the first information to the first source.

2. The method of claim 1 wherein the action performed by the user comprises accessing a first web page and the information request comprises content information displayed by the first web page.

3. The method of claim 1 wherein:
the action performed by the user comprises requesting purchase of a plurality of items;
the information request comprises information identifying the plurality of items; and
the first information comprises information related to purchasable items corresponding to the plurality of items.

4. The method of claim 1 wherein the first source is a first computer, and the method further comprises outputting the first information to the user via the first computer.

5. The method of claim 1 wherein:
the information request comprises content information related to a plurality of items,
determining the first set of tokens from the plurality of tokens corresponding to the information request comprises:
extracting keywords related to the plurality of items from the content information;
determining the first set of tokens corresponding to the keywords; and
the first information comprises information related to purchasable items corresponding to the plurality of items.

6. The method of claim 5 wherein the first information comprises promotional information, branding information, and marketing information provided by a plurality of vendors for the first set of tokens.

7. The method of claim 5 wherein extracting the keywords related to the plurality of items from the content information comprises extracting a quantity value associated with at least one keyword extracted from the content information.

8. The method of claim 7 wherein extracting the keywords related to the plurality of items from the content information comprises extracting a unit of measure associated with the quantity value.

9. The method of claim 1 wherein determining the first set of tokens from the plurality of tokens corresponding to the information request comprises:
extracting a first plurality of keywords from the information request; and
determining the first set of tokens corresponding to the first plurality of keywords.

10. The method of claim 9 wherein:
extracting the first plurality of keywords from the information request comprises:
storing a list of keywords; and
identifying a keyword as belonging to the first plurality of keywords if the keyword is included in the information request and in the list of keywords; and
determining the first set of tokens corresponding to the first plurality of keywords comprises:
storing a second set of rules identifying tokens from the plurality of tokens corresponding to keywords in the list of keywords; and
determining the first set of tokens corresponding to the first plurality of keywords based upon the second set of rules.

11. The method of claim 10 wherein:
the list of keywords includes keywords specified by a plurality of vendors; and
the second set of rules includes rules specified by the plurality of vendors.

12. The method of claim 1 wherein:
the first set of rules includes a first rule specifying a first condition involving a category associated with at least one token from the plurality of tokens and identifying information to be communicated to the user if the first condition is satisfied; and
determining the first information corresponding to the first set of tokens based upon the first set of rules comprises:
determining if the first condition of the first rule is satisfied by tokens in the first set of tokens; and
if the first condition is satisfied, including the information identified by the first rule in the first information.

13. The method of claim 1 wherein the first set of rules include rules configured by a plurality of vendors and the information associated with the plurality of tokens comprises vendor-configured information.

14. The method of claim 1 wherein determining the first information corresponding to the first set of tokens based upon the first set of rules comprises:
determining a second set of rules from the first plurality of rules, the second set of rules including rules associated with the first set of tokens; and
determining the first information based on the second set of rules, the first information comprising information specified by the second set of rules.

15. The method of claim 1 further comprising:
storing preferences for the user;
filtering the first information to include information which satisfies the user preferences; and
wherein communicating the first information to the first source comprises communicating the filtered first information to the first source.

16. The method of claim 1 wherein:
the first set of rules includes a first rule provided by a first vendor, the first rule specifying a first condition involving at least one token from the plurality of tokens and identifying information provided by the first vendor to be communicated to the user if the first condition is satisfied; and
determining the first information corresponding to the first set of tokens based upon the first set of rules comprises:
determining if the first condition of the first rule is satisfied by tokens in the first set of tokens; and
if the first condition is satisfied, including the information provided by the first vendor in the first information.

17. The method of claim 1 further comprising:
modifying the first set of rules by modifying the associations between the plurality of tokens and information associated with the plurality of tokens; and
wherein determining the first information corresponding to the first set of tokens based upon the first set of rules comprising determining the first information based upon the modified first set of rules.

18. In a network comprising a plurality of computers, a computer-implemented method of providing information in response to an information request, the method comprising:
receiving the information request from a first source, the information request generated in response to an action performed by the user;
determining a plurality of tokens corresponding to the information request;
determining a plurality of vendors corresponding to the plurality of tokens;
determining first information provided by the plurality of vendors corresponding to the plurality of tokens; and
communicating the first information to the first source.

19. In a network comprising a plurality of computers, a computer-implemented method of providing information in response to an information request, the method comprising:
receiving the information request from a first computer system, the information request generated in response to an action performed by the user;
determining a plurality of tokens corresponding to the information request;
determining a plurality of vendors corresponding to the plurality of tokens;
for each vendor from the plurality of vendors:
determining a set of tokens from the plurality of tokens associated with the vendor;
communicating information related to the set of tokens to the vendor; and
in response, receiving information from the vendor corresponding to the set of tokens; and
communicating information received from the plurality of vendors to the first computer system.
